(19) United States
(12) Patent Application Publication
(10) Pub. No.: US 2025/0188641 A1
(43) Pub. Date: Jun. 12, 2025

(54) PLATING APPARATUS

(71) Applicant: EBARA CORPORATION, Tokyo (JP)

(72) Inventor: Masaya SEKI, Tokyo (JP)

(21) Appl. No.: 18/281,753

(22) PCT Filed: Dec. 9, 2022
(86) PCT No.: PCT/JP2022/045415

§ 371 Date: Jan. 13, 2025

(51) Int. Cl. C25D 21/10; C25D 21/12

(52) U.S. Cl. CPC C25D 21/10; C25D 21/12

(57) ABSTRACT

To suppress a central portion of a paddle from hanging down in a cup type plating apparatus.

A plating apparatus includes a plating tank 410 for housing a plating solution, an anode disposed inside the plating tank 410, a substrate holder configured to hold a substrate Wf with a surface to be plated Wf-a facing downward, a paddle 460 disposed between the anode and the substrate Wf, a driving mechanism 462 configured to support a base end portion 460A of the paddle 460 and reciprocate the paddle 460 along the surface to be plated Wf-a of the substrate Wf, a first magnet 464 disposed in the paddle 460, and a second magnet 468 disposed to be opposed to the first magnet 464. The first magnet 464 and the second magnet 468 are configured to exert a magnetic force on one another so as to cause a central portion 460C between the base end portion 460A and a distal end portion 460B of the paddle 460 to approach the surface to be plated Wf-a of the substrate Wf.

### TECHNICAL FIELD This application relates to a plating apparatus.

### BACKGROUND ART

There has been known an electroplating apparatus for forming a conductive film on a surface to be plated of a substrate (for example, a semiconductor wafer). For example, PTL 1 discloses a so-called dip type electroplating apparatus in which a substrate is immersed in a plating solution in an upright state to perform a plating process. On the other hand, as one example of the plating apparatus, there has been known a so-called cup type electroplating apparatus in which a substrate is immersed in a plating solution in a laid state.

The dip type electroplating apparatus disclosed in PTL 1 includes a paddle disposed near a surface to be plated of a substrate and is configured to stir a plating solution near the surface to be plated by reciprocating the paddle along the surface to be plated of the substrate. In this electroplating apparatus, an upper end of the paddle is supported, and since a lower end of the paddle vibrates during stirring of the plating solution, this electroplating apparatus is configured to have magnets at each of the lower end of the paddle and a plating tank to suppress the vibration of the lower end of the paddle by magnetic forces of these magnets.

### CITATION LIST

### Patent Literature

PTL 1: Japanese Patent No. 6329681

### SUMMARY OF INVENTION

### Technical Problem

When the technique disclosed in PTL 1 is applied to a cup type plating apparatus, there arises a new problem that a central portion of the paddle hangs down.

That is, in the cup type plating apparatus, when a base end portion of a paddle is physically supported, and magnets are disposed at a distal end portion of the paddle and a plating tank to support (suppress vibrations) the distal end portion of the paddle by these magnetic forces, the central portion of the paddle is likely to hang down by gravity. When the paddle bends, and the central portion of which hangs down, since the paddle is likely to interfere with an ionically resistive element disposed below the paddle and generate particles, it is unpreferable.

Therefore, it is an object of this application to suppress a central portion of a paddle from hanging down in a cup type plating apparatus.

### Solution to Problem

According to one embodiment, a plating apparatus is disclosed. The plating apparatus includes a plating tank for housing a plating solution, an anode disposed inside the plating tank, a substrate holder configured to hold a substrate with a surface to be plated facing downward, a paddle disposed between the anode and the substrate, a paddle driving mechanism configured to support a base end portion of the paddle and reciprocate the paddle along the surface to be plated of the substrate, a first magnet disposed in the paddle, and a second magnet disposed to be opposed to the first magnet. The first magnet and the second magnet are configured to exert a magnetic force on one another so as to cause a central portion between the base end portion and a distal end portion of the paddle to approach the surface to be plated of the substrate.

### BRIEF DESCRIPTION OF DRAWINGS

FIG. 1 is a perspective view illustrating an overall configuration of a plating apparatus according to an embodiment.

FIG. 2 is a plan view illustrating the overall configuration of the plating apparatus according to the embodiment.

FIG. 3 is a vertical cross-sectional view schematically illustrating a configuration of a plating module according to one embodiment.

FIG. 4A is a plan view schematically illustrating a configuration of a paddle.

FIG. 4B is a plan view schematically illustrating a configuration of a paddle.

FIG. 5 is a vertical cross-sectional view schematically illustrating an enlarged part of the configuration of the plating module according to one embodiment.

FIG. 6 is a vertical cross-sectional view schematically illustrating an enlarged part of a configuration of a plating module according to one embodiment.

FIG. 7 is a vertical cross-sectional view schematically illustrating an enlarged part of a configuration of a plating module according to one embodiment.

FIG. 8 is a vertical cross-sectional view schematically illustrating an enlarged part of a configuration of a plating module according to one embodiment.

FIG. 9 is a vertical cross-sectional view schematically illustrating an enlarged part of a configuration of a plating module according to one embodiment.

### DESCRIPTION OF EMBODIMENTS

The following describes embodiments according to the present invention with reference to the attached drawings. In the drawings described below, identical reference numerals are given to identical or equivalent components, and duplicate descriptions will be omitted.

### Overall Configuration of Plating Apparatus

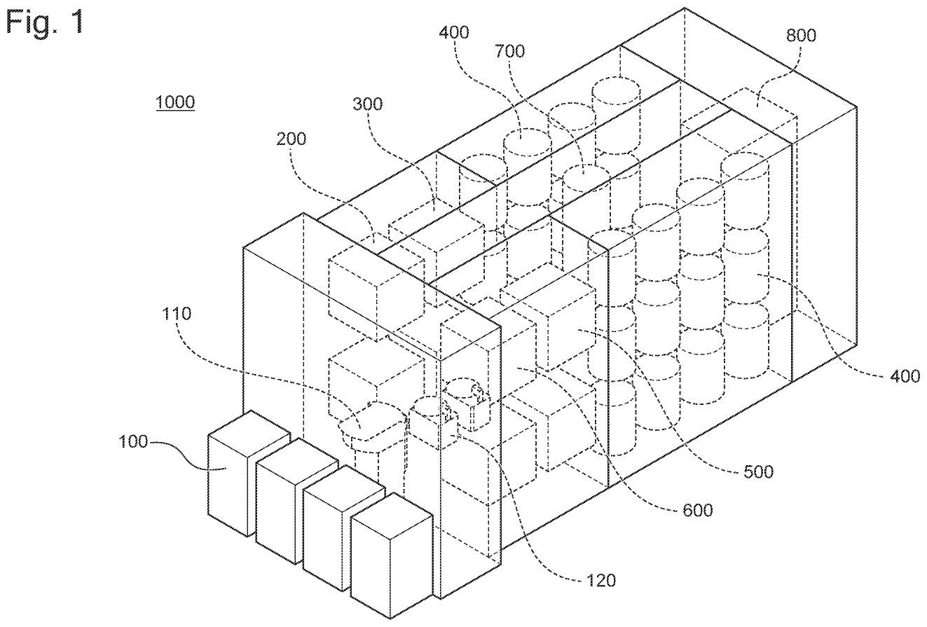

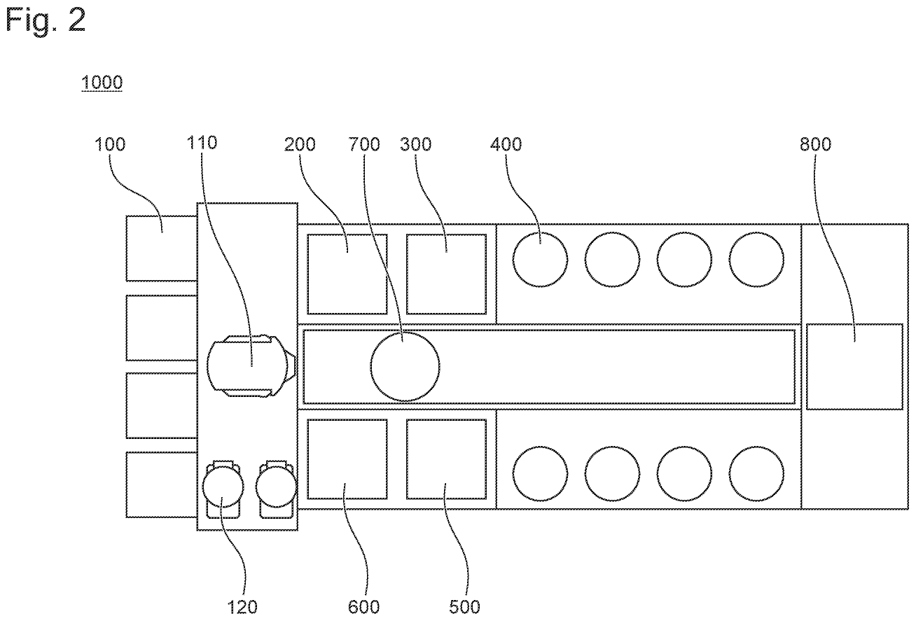

FIG. 1 is a perspective view illustrating the overall configuration of the plating apparatus of this embodiment. FIG. 2 is a plan view illustrating the overall configuration of the plating apparatus of this embodiment. As illustrated in FIGS. 1 and 2, a plating apparatus 1000 includes load ports 100, a transfer robot 110, aligners 120, pre-wet modules 200, pre-soak modules 300, plating modules 400, cleaning modules 500, spin rinse dryers 600, a transfer device 700, and a control module 800.

The load port 100 is a module for loading a substrate housed in a cassette, such as a FOUP, (not illustrated) to the plating apparatus 1000 and unloading the substrate from the plating apparatus 1000 to the cassette. While the four load ports 100 are arranged in the horizontal direction in this embodiment, the number of load ports 100 and arrangement of the load ports 100 are arbitrary. The transfer robot 110 is a robot for transferring the substrate that is configured to grip or release the substrate between the load port 100, the aligner 120, the pre-wet module 200, and the spin rinse dryers 600. The transfer robot 110 and the transfer device 700 can perform delivery and receipt of the substrate via a temporary placement table (not illustrated) to grip or release the substrate between the transfer robot 110 and the transfer device 700.

The aligner 120 is a module for adjusting a position of an orientation flat, a notch, and the like of the substrate in a predetermined direction. While the two aligners 120 are disposed to be arranged in the horizontal direction in this embodiment, the number of aligners 120 and arrangement of the aligners 120 are arbitrary. The pre-wet module 200 wets a surface to be plated of the substrate before a plating process with a process liquid, such as pure water or deaerated water, to replace air inside a pattern formed on the surface of the substrate with the process liquid. The pre-wet module 200 is configured to perform a pre-wet process to facilitate supplying the plating solution to the inside of the pattern by replacing the process liquid inside the pattern with a plating solution during plating. While the two pre-wet modules 200 are disposed to be arranged in the vertical direction in this embodiment, the number of pre-wet modules 200 and arrangement of the pre-wet modules 200 are arbitrary.

For example, the pre-soak module 300 is configured to remove an oxidized film having a large electrical resistance present on, a surface of a seed layer formed on the surface to be plated of the substrate before the plating process by etching with a process liquid, such as sulfuric acid and hydrochloric acid, and perform a pre-soak process that cleans or activates a surface of a plating base layer. While the two pre-soak modules 300 are disposed to be arranged in the vertical direction in this embodiment, the number of pre-soak modules 300 and arrangement of the pre-soak modules 300 are arbitrary. The plating module 400 performs the plating process on the substrate. There are two sets of the 12 plating modules 400 arranged by three in the vertical direction and by four in the horizontal direction, and the total 24 plating modules 400 are disposed in this embodiment, but the number of plating modules 400 and arrangement of the plating modules 400 are arbitrary.

The cleaning module 500 is configured to perform a cleaning process on the substrate to remove the plating solution or the like left on the substrate after the plating process. While the two cleaning modules 500 are disposed to be arranged in the vertical direction in this embodiment, the number of cleaning modules 500 and arrangement of the cleaning modules 500 are arbitrary. The spin rinse dryer 600 is a module for rotating the substrate after the cleaning process at high speed and drying the substrate. While the two spin rinse dryers are disposed to be arranged in the vertical direction in this embodiment, the number of spin rinse dryers and arrangement of the spin rinse dryers are arbitrary. The transfer device 700 is a device for transferring the substrate between the plurality of modules inside the plating apparatus 1000. The control module 800 is configured to control the plurality of modules in the plating apparatus 1000 and can be configured of, for example, a general computer including input/output interfaces with an operator or a dedicated computer.

An example of a sequence of the plating processes by the plating apparatus 1000 will be described. First, the substrate housed in the cassette is loaded on the load port 100. Subsequently, the transfer robot 110 grips the substrate from the cassette at the load port 100 and transfers the substrate to the aligners 120. The aligner 120 adjusts the position of the orientation flat, the notch, or the like of the substrate in the predetermined direction. The transfer robot 110 grips or releases the substrate whose direction is adjusted with the aligners 120 to the pre-wet module 200.

The pre-wet module 200 performs the pre-wet process on the substrate. The transfer device 700 transfers the substrate on which the pre-wet process has been performed to the pre-soak module 300. The pre-soak module 300 performs the pre-soak process on the substrate. The transfer device 700 transfers the substrate on which the pre-soak process has been performed to the plating module 400. The plating module 400 performs the plating process on the substrate.

The transfer device 700 transfers the substrate on which the plating process has been performed to the cleaning module 500. The cleaning module 500 performs the cleaning process on the substrate. The transfer device 700 transfers the substrate on which the cleaning process has been performed to the spin rinse dryer 600. The spin rinse dryer 600 performs the drying process on the substrate. The transfer robot 110 receives the substrate from the spin rinse dryer 600 and transfers the substrate, on which the drying process is performed, to the cassette at the load port 100. Finally, the cassette housing the substrate is unloaded from the load port 100.

### Configuration of Plating Module

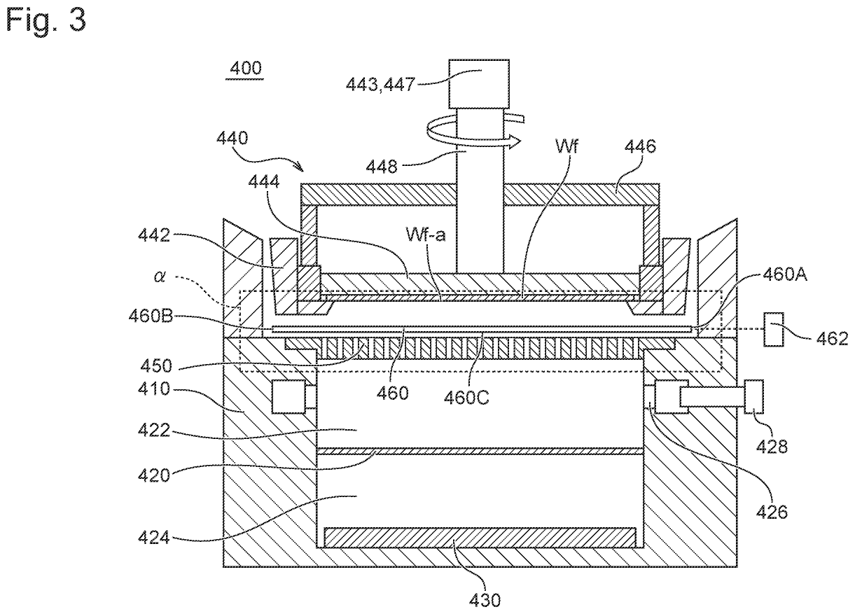

Next, the configuration of the plating module 400 will be described. Since the 24 plating modules 400 in the embodiment have the same configuration, only one plating module 400 will be described. FIG. 3 is a vertical cross-sectional view schematically illustrating a configuration of a plating module according to one embodiment.

As illustrated in FIG. 3, the plating module 400 includes a plating tank 410 for housing the plating solution. The plating module 400 includes a membrane 420 separating an inside of the plating tank 410 in an up-down direction. The inside of the plating tank 410 is partitioned into a cathode region 422 and an anode region 424 by the membrane 420.

The cathode region 422 and the anode region 424 are each filled with the plating solution. The plating module 400 includes a nozzle 426 opening toward the cathode region 422 and a supply source 428 for supplying the cathode region 422 with the plating solution via the nozzle 426. While, similarly for the anode region 424, the plating module 400 also includes a mechanism for supplying the anode region 424 with the plating solution, illustration will be omitted. An anode 430 is disposed on a bottom surface of the plating tank 410 in the anode region 424. In the cathode region 422, an ionically resistive element 450 is arranged to be opposed to the membrane 420. The ionically resistive element 450 is a member for making the plating process uniform on a surface to be plated Wf-a of a substrate Wf and is constituted of a plate-shaped member having many holes.

The plating module 400 includes a substrate holder 440 for holding the substrate Wf with the surface to be plated Wf-a of the substrate Wf facing downward. The substrate holder 440 includes a power feeding contact point for feeding power to the substrate Wf from a power source (not illustrated). The substrate holder 440 includes a seal ring holder 442 for supporting an outer edge portion of the surface to be plated Wf-a of the substrate Wf and a frame 446 for holding the seal ring holder 442 on a substrate holder main body (not illustrated). The substrate holder 440 includes a back plate 444 for pressing a backside surface of the surface to be plated Wf-a of the substrate Wf and a shaft 448 mounted on a backside surface of a substrate pressing surface of the back plate 444.

The plating module 400 includes an elevating and lowering mechanism 443 for elevating and lowering the substrate holder 440 and a rotation mechanism 447 for rotating the substrate holder 440 so as to rotate the substrate Wf around a virtual axis (a virtual rotation axis extending perpendicularly through a center of the surface to be plated Wf-a) of the shaft 448. The elevating and lowering mechanism 443 and the rotation mechanism 447 can be achieved by a known mechanism, for example, a motor or the like. The plating module 400 is configured to perform a plating process on the surface to be plated Wf-a of the substrate Wf by immersing the substrate Wf in the plating solution of the cathode region 422 using the elevating and lowering mechanism 443 and applying a voltage between the anode 430 and the substrate Wf.

The plating module 400 includes a paddle 460 disposed between the anode 430 and the substrate Wf, specifically between the ionically resistive element 450 and the substrate Wf. The paddle 460 is disposed to be opposed to the surface to be plated Wf-a of the substrate Wf. The plating module 400 includes a driving mechanism 462 that physically supports a base end portion 460A of the paddle 460 and reciprocates the paddle 460 along the surface to be plated Wf-a of the substrate Wf. The driving mechanism 462 can be achieved by a known mechanism, for example, a motor or the like.

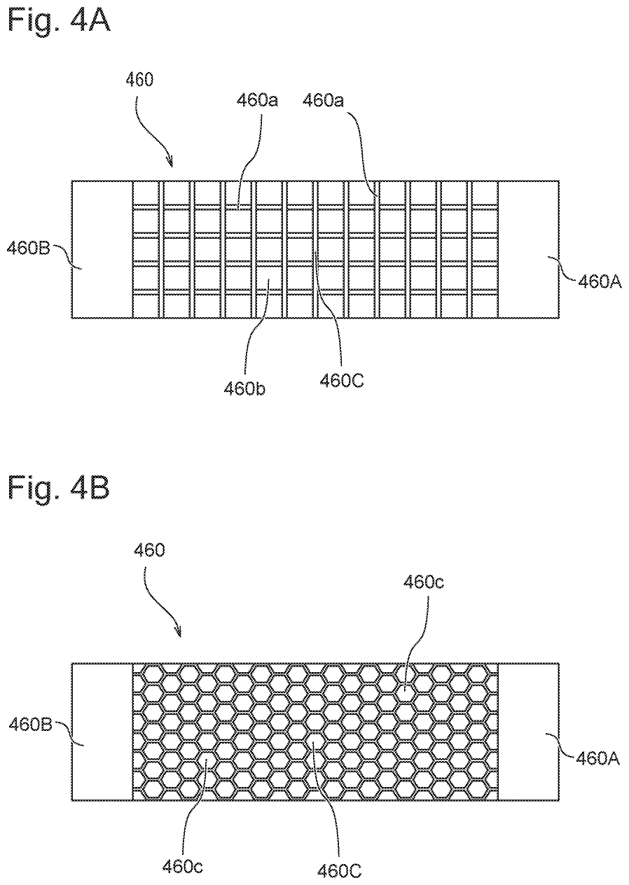

FIG. 4A and FIG. 4B are plan views schematically illustrating configurations of the paddles. As illustrated in FIG. 4A, the paddle 460 can be configured by a plate member in which many holes 460b are formed by disposing a plurality of rod-shaped members 460a in a grid pattern. The paddle 460 is configured with the base end portion 460A, a distal end portion 460B opposite to the base end portion 460A, and a central portion 460C between the base end portion 460A and the distal end portion 460B. As illustrated in FIG. 4B, the paddle 460 can also be configured by a plate member in which many honeycomb-shaped holes 460c are formed. By reciprocating the paddle 460 with the driving mechanism 462, it is possible to stir the plating solution near the surface to be plated Wf-a of the substrate Wf and facilitate the plating process. In FIG. 4A and FIG. 4B, while the paddle 460 is indicated to have a rectangular shape in plan view, the shape of the paddle 460 is not limited to this and is appropriately employed.

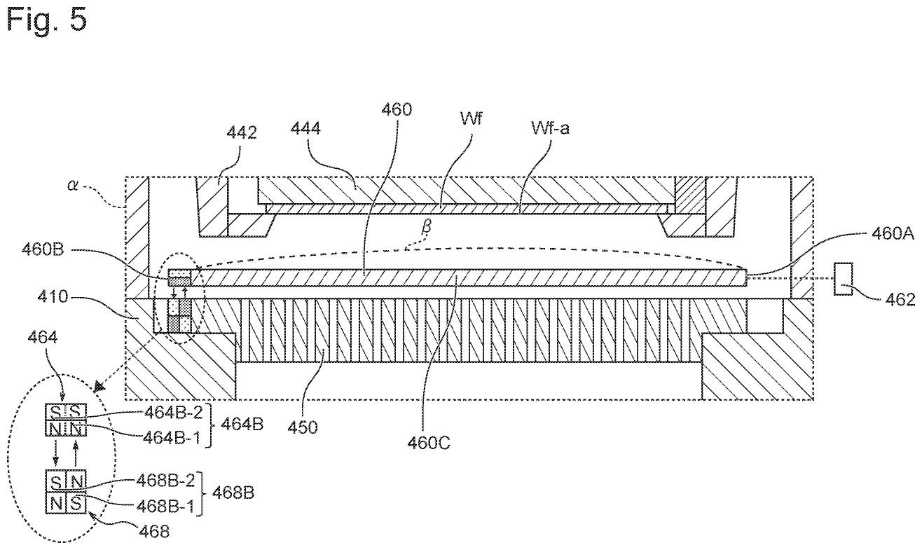

FIG. 5 is a vertical cross-sectional view schematically illustrating an enlarged part of a configuration of a plating module according to one embodiment. FIG. 5 schematically illustrates an enlarged part of the dashed line a in FIG. 3. As illustrated in FIG. 5, the plating module 400 includes a first magnet 464 disposed in the paddle 460 and a second magnet 468 disposed so as to be opposed to the first magnet 464.

More specifically, the first magnet 464 includes a distal-end magnet portion 464B disposed at the distal end portion 460B of the paddle 460. The distal-end magnet portion 464B has a distal-end-inside magnet portion 464B-1 and a distal-end-outside magnet portion 464B-2 disposed along an extending direction of the paddle 460. The distal-end-inside magnet portion 464B-1 is disposed at a position corresponding to an inside of a most distal end of the paddle 460 and has an N-pole disposed at a lower portion and an S-pole disposed at an upper portion. The distal-end-outside magnet portion 464B-2 is disposed at a position corresponding to the most distal end of the paddle 460 and has the N-pole disposed at a lower portion and the S-pole disposed at an upper portion.

The second magnet 468 is disposed in the plating tank 410 so as to be opposed to a lower surface of the first magnet 464. The second magnet 468 includes a first inside magnet portion 468B-1 configured to exert a magnetic force that lifts the distal-end-inside magnet portion 464B-1. Specifically, the first inside magnet portion 468B-1 has the pole (the N-pole) disposed at an upper portion, which is the same pole as the lower portion (the N-pole) of the distal-end-inside magnet portion 464B-1, and the S-pole disposed at a lower portion. The first inside magnet portion 468B-1 is secured to the plating tank 410, and by the first inside magnet portion 468B-1 and the distal-end-inside magnet portion 464B-1 repelling one another, the magnetic force lifting the distal-end-inside magnet portion 464B-1 is generated.

The second magnet 468 includes a first outside magnet portion 468B-2 configured to exert a magnetic force that lowers the distal-end-outside magnet portion 464B-2. Specifically, the first outside magnet portion 468B-2 has the pole (the S-pole) disposed at an upper portion, which is the opposite pole to the lower portion (the N-pole) of the distal-end-outside magnet portion 464B-2, and the N-pole disposed at a lower portion. The first outside magnet portion 468B-2 is secured to the plating tank 410, and by the first outside magnet portion 468B-2 and the distal-end-outside magnet portion 464B-2 attracting one another, the magnetic force lowering the first outside magnet portion 464B-2 is generated.

In view of this, as illustrated in FIG. 5, since the magnetic force lowering the most distal end of the paddle 460 and the magnetic force lifting the inside of the most distal end are generated, a force that lifts the central portion 460C of the paddle 460 is generated. Consequently, it is possible to suppress the central portion 460C of the paddle 460 from hanging down toward the ionically resistive element 450 side. That is, since the paddle 460 has a smaller thickness with respect to a length from the base end portion 460A to the distal end portion 460B, the paddle 460 easily bends by gravity. In particular, when a resin having low rigidity is used as a material of the paddle 460, even when the base end portion 460A of the paddle 460 is physically supported, and hanging down of the distal end portion 460B is supported by a magnetic force, the central portion 460C is likely to hang down toward the ionically resistive element 450 side. In contrast to this, in this embodiment, the first magnet 464 and the second magnet 468 are configured to exert the magnetic force on one another such that the central portion 460C of the paddle 460 approaches the surface to be plated Wf-a of the substrate Wf. This allows suppressing the central portion 460C of the paddle 460 from hanging down toward the ionically resistive element 450 side and consequently, suppressing particles due to interference of the paddle 460 with the ionically resistive element 450 from being generated.

The force that lifts the central portion 460C of the paddle 460 depends on the magnetic force acting between the first magnet 464 and the second magnet 468. By adjusting the magnetic force acting on both, the paddle 460 can be kept substantially horizontal as illustrated in FIG. 5. By further strengthening the magnetic force acting on both, as illustrated by the dashed line ß in FIG. 5, the paddle 460 can be kept in an arched shape such that the central portion 460C of the paddle 460 projects toward the surface to be plated Wf-a side of the substrate Wf. Thus, since the paddle 460 approaches the surface to be plated Wf-a of the substrate Wf, it is possible to improve the stirring action of the plating solution near the surface to be plated Wf-a. In particular, as in the embodiment, in a case of employing the substrate holder 440 having the seal ring holder 442 that supports the outer edge portion of the surface to be plated Wf-a, when the entire paddle 460 is brought close to the surface to be plated Wf-a, interference between the paddle 460 and the seal ring holder 442 becomes a problem. In this respect, as in the embodiment, by making the paddle 460 arched-shape, the paddle 460 can be brought close to the surface to be plated Wf-a while interference with the seal ring holder 442 is avoided.

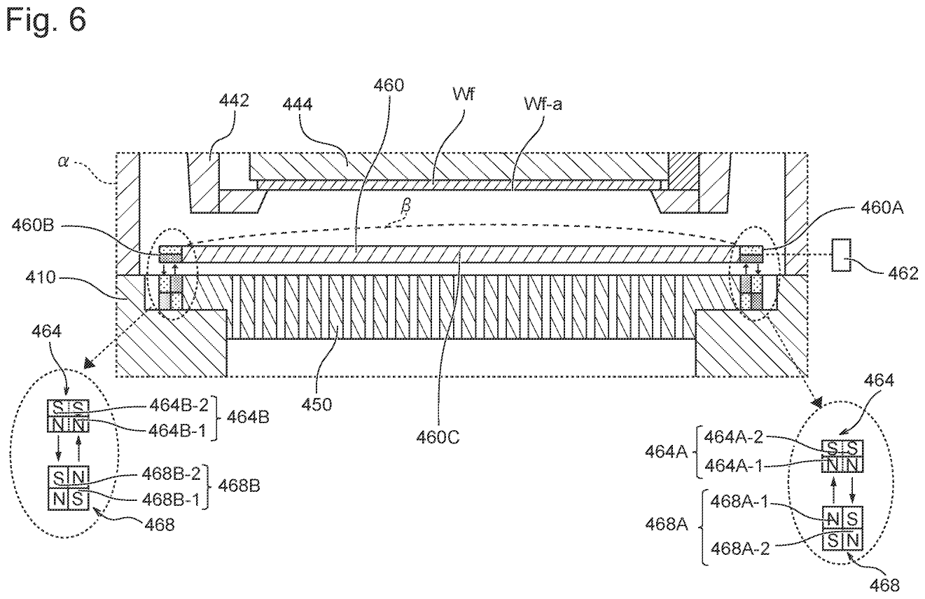

Next, a modification of the plating module 400 will be described. FIG. 6 is a vertical cross-sectional view schematically illustrating an enlarged part of a configuration of a plating module according to one embodiment. The plating module 400 illustrated in FIG. 6 has a configuration similar to that of the plating module 400 illustrated in FIG. 5 and is different in that a magnet is additionally also disposed on the base end portion 460A side of the paddle 460. The descriptions of the configuration similar to that in FIG. 5 will be omitted.

As illustrated in FIG. 6, the first magnet 464 further includes a base-end magnet portion 464A disposed at the base end portion 460A of the paddle 460. The base-end magnet portion 464A has a base-end-inside magnet portion 464A-1 and a base-end-outside magnet portion 464A-2 disposed along the extending direction of the paddle 460. The base-end-inside magnet portion 464A-1 is disposed at a position corresponding to an inside of a most base end of the paddle 460 and has the N-pole disposed at a lower portion and the S-pole disposed at an upper portion. The base-end-outside magnet portion 464A-2 is disposed at a position corresponding to the most base end of the paddle 460 and has the N-pole disposed at a lower portion and the S-pole disposed at an upper portion.

The second magnet 468 includes a second inside magnet portion 468A-1 configured to exert the magnetic force that lifts the base-end-inside magnet portion 464A-1. Specifically, the second inside magnet portion 468A-1 has the pole (the N-pole) disposed at an upper portion, which is the same pole as the lower portion (the N-pole) of the base-end-inside magnet portion 464A-1, and the S-pole disposed at a lower portion. The second inside magnet portion 468A-1 is secured to the plating tank 410, and by the second inside magnet portion 468A-1 and the base-end-inside magnet portion 464A-1 repelling one another, the magnetic force that lifts the second inside magnet portion 464A-1 is generated.

The second magnet 468 includes a second outside magnet portion 468A-2 configured to exert the magnetic force that lower the base-end-outside magnet portion 464A-2. Specifically, the second outside magnet portion 468A-2 has the pole (the S-pole) disposed at an upper portion, which is the opposite pole to the lower portion (the N-pole) of the base-end-outside magnet portion 464A-2, and the N-pole disposed at a lower portion. The second outside magnet portion 468A-2 is secured to the plating tank 410, and by the second outside magnet portion 468A-2 and the base-end-outside magnet portion 464A-2 attracting with one another, the magnetic force that lowers the second outside magnet portion 464A-2 is generated.

Since not only on the distal end portion 460B side of the paddle 460, but also on the base end portion 460A side, the magnetic force that lowers the most base end of the paddle 460 and the magnetic force that lifts the inside of the most base end are generated, the magnetic forces act such that the central portion 460C of the paddle 460 approaches the surface to be plated Wf-a of the substrate Wf. Consequently, it is possible to more strongly suppress the central portion 460C of the paddle 460 from hanging down toward the ionically resistive element 450 side.

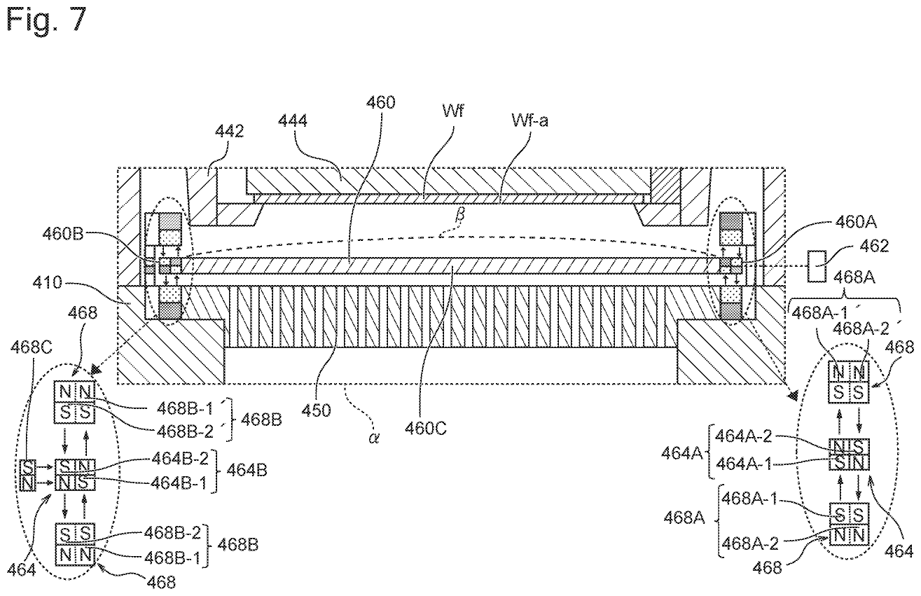

Next, a modification of the plating module 400 will be described. FIG. 7 is a vertical cross-sectional view schematically illustrating an enlarged part of a configuration of a plating module according to one embodiment. While, in the embodiments illustrated in FIG. 5 and FIG. 6, the second magnet 468 is disposed in the plating tank 410 so as to be opposed to the lower surface of the first magnet 464, in addition to this, it may be disposed in the plating tank 410 so as to be opposed to the upper surface of the first magnet 464. This point will be described below.

As illustrated in FIG. 7, in this embodiment, a distal-end-inside magnet portion 464B-1 has the S-pole disposed at a lower portion and the N-pole disposed at an upper portion. A distal-end-outside magnet portion 464B-2 has the N-pole disposed at a lower portion and the S-pole disposed at an upper portion.

The second magnets 468 are disposed in the plating tank 410 so as to sandwich the distal-end magnet portion 464B in the up-down direction, in other words, so to be opposed to an upper surface and a lower surface of the distal-end magnet portion 464B. Specifically, a first inside magnet portion 468B-1 opposed to a lower surface of the distal-end-inside magnet portion 464B-1 has the pole (the S-pole) disposed at an upper portion, which is the same pole as the lower portion (the S-pole) of the distal-end-inside magnet portion 464B-1, and the N-pole disposed at a lower portion. A first inside magnet portion 468B-1′ opposed to the upper surface of the distal-end-inside magnet portion 464B-1 has the pole (the S-pole) disposed at a lower portion, which is the opposite pole to the upper portion (the N-pole) of the distal-end-inside magnet portion 464B-1, and the N-pole disposed at an upper portion. Thus, a magnetic force that lifts the distal-end-inside magnet portion 464B-1 acts thereon.

The first outside magnet portion 468B-2 opposed to a lower surface of the distal-end-outside magnet portion 464B-2 has the pole (the S-pole) disposed at an upper portion, which is the opposite pole to the lower portion (the N-pole) of the distal-end-outside magnet portion 464B-2, and the N-pole disposed at a lower portion. A first outside magnet portion 468B-2′ opposed to an upper surface of the distal-end-outside magnet portion 464B-2 has the pole (the S-pole) disposed at a lower portion, which is the same pole as the upper portion (the S-pole) of the distal-end-outside magnet portion 464B-2, and the N-pole disposed at an upper portion. Thus, a magnetic force that lowers the distal-end-outside magnet portion 464B-2 acts thereon.

In this embodiment, the base-end-inside magnet portion 464A-1 has the S-pole disposed at a lower portion and the N-pole disposed at an upper portion. The base-end-outside magnet portion 464A-2 has the N-pole disposed at a lower portion and the S-pole disposed at an upper portion.

The second magnets 468 are disposed in the plating tank 410 so as to sandwich the base-end magnet portion 464A in the up-down direction, in other words, to be opposed to an upper surface and a lower surface of the base-end magnet portion 464A. Specifically, the second inside magnet portion 468A-1 opposed to a lower surface of the base-end-inside magnet portion 464A-1 has the pole (the S-pole) disposed at an upper portion, which is the same pole as the lower portion (the S-pole) of the base-end-inside magnet portion 464A-1, and the N-pole disposed at a lower portion. A second inside magnet portion 468A-1′ opposed to an upper surface of the base-end-inside magnet portion 464A-1 has the pole (the S-pole) disposed at a lower portion, which is the opposite pole to the upper portion (the N-pole) of the base-end-inside magnet portion 464A-1, and the N-pole disposed at an upper portion. Thus, a magnetic force that lifts the base-end-inside magnet portion 464A-1 acts thereon.

The second outside magnet portion 468A-2 opposed to a lower surface of the base-end-outside magnet portion 464A-2 has the pole (the S-pole) disposed at an upper portion, which is the opposite pole to the lower portion (the N-pole) of the base-end-outside magnet portion 464A-2, and the N-pole disposed at a lower portion. A second outside magnet portion 468A-2′ opposed to an upper surface of the base-end-outside magnet portion 464A-2 has the pole (the S-pole) disposed at a lower portion, which is the same pole as the upper portion (the S-pole) of the base-end-outside magnet portion 464A-2, and the N-pole disposed at an upper portion. Thus, a magnetic force that lowers the base-end-outside magnet portion 464A-2 acts thereon.

As described above, according to this embodiment, the second magnets 468 are disposed not only at the lower portions of the distal-end magnet portion 464B and the base-end magnet portion 464A but also at the upper portions of them. Accordingly, since the strong magnetic force acts so as to cause the central portion 460C of the paddle 460 to approach the surface to be plated Wf-a of the substrate Wf, it is possible to more strongly suppress the central portion 460C of the paddle 460 from hanging down toward the ionically resistive element 450 side.

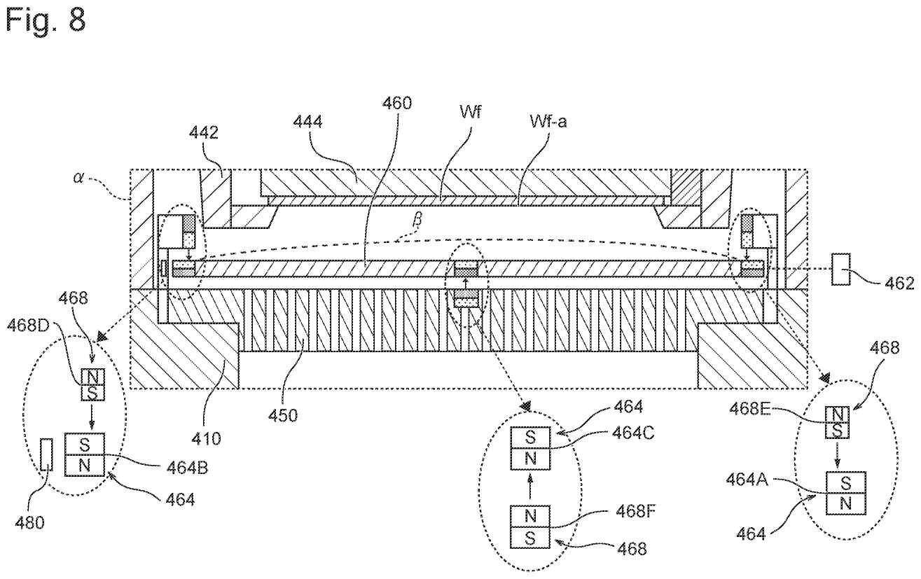

Furthermore, in this embodiment, the second magnet 468 includes a distal-end-opposition magnet portion 468C disposed in the plating tank 410 to be opposed to the distal-end magnet portion 464B (the distal-end-outside magnet portion 464B-2) in the extending direction of the paddle 460. The distal-end-opposition magnet portion 468C is configured to exert a repulsive magnetic force on the distal-end magnet portion 464B. Specifically, the distal-end-opposition magnet portion 468C has the N-pole disposed at a lower portion and the S-pole at an upper portion. The distal-end-outside magnet portion 464B-2 also has the N-pole disposed at the lower portion and the S-pole at the upper portion. Accordingly, since the magnetic forces that repel one another are generated between the distal-end-opposition magnet portion 468C and the distal-end-outside magnet portion 464B-2, it is possible to enhance a force that arches the paddle 460. The distal-end-opposition magnet portion 468C is not limited to this embodiment and can be applied to the embodiments illustrated in FIG. 5, FIG. 6, or FIG. 8.

Next, a modification of the plating module 400 will be described. FIG. 8 is a vertical cross-sectional view schematically illustrating an enlarged part of a configuration of a plating module according to one embodiment.

In this embodiment, the first magnet 464 includes the distal-end magnet portion 464B disposed at the distal end portion 460B of the paddle 460, the base-end magnet portion 464A disposed at the base end portion 460A of the paddle 460, and the central magnet portion 464C disposed at the central portion 460C of the paddle 460. Specifically, the distal-end magnet portion 464B has the N-pole disposed at a lower portion and the S-pole disposed at an upper portion. The base-end magnet portion 464A has the N-pole disposed at a lower portion and the S-pole disposed at an upper portion. The central magnet portion 464C has the N-pole disposed at a lower portion and the S-pole disposed at an upper portion.

The second magnet 468 has a first plating-tank magnet portion 468D disposed in the plating tank 410 so as to exert a magnetic force that lowers the distal-end magnet portion 464B. The first plating-tank magnet portion 468D is disposed in the plating tank 410 so as to be opposed to an upper surface of the distal-end magnet portion 464B. The first plating-tank magnet portion 468D has the pole (the S-pole) disposed at a lower portion, which is the same pole as the upper portion (the S-pole) of the distal-end magnet portion 464B, and the N-pole disposed at an upper portion. The first plating-tank magnet portion 468D is secured to the plating tank 410, and by the first plating-tank magnet portion 468D and the distal-end magnet portion 464B repelling one another, a magnetic force that lowers the distal-end magnet portion 464B is generated.

The second magnet 468 has a second plating-tank magnet portion 468E disposed in the plating tank 410 so as to exert a magnetic force that lowers the base-end magnet portion 464A. The second plating-tank magnet portion 468E is disposed in the plating tank 410 so as to be opposed to an upper surface of the base-end magnet portion 464A. The second plating-tank magnet portion 468E has the pole (the S-pole) disposed at a lower portion, which is the same pole as the upper portion (the S-pole) of the base-end magnet portion 464A, and the N-pole disposed at an upper portion. The second plating-tank magnet portion 468E is secured to the plating tank 410, and by the second plating-tank magnet portion 468E and the base-end magnet portion 464A repelling one another, a magnetic force that lowers the base-end magnet portion 464A is generated.

The second magnet 468 has an ionically-resistive-element magnet portion 468F disposed in the ionically resistive element 450 so as to exert a magnetic force that lifts the central magnet portion 464C. The ionically-resistive-element magnet portion 468F is disposed in the ionically resistive element 450 so as to be opposed to a lower surface of the central magnet portion 464C. The ionically-resistive-element magnet portion 468F has the pole (the N-pole) disposed at an upper portion, which is the same pole as the lower portion (the N-pole) of the central magnet portion 464C, and the S-pole at a lower. The ionically-resistive-element magnet portion 468F is secured to the ionically resistive element 450, and by the ionically-resistive-element magnet portion 468F and the central magnet portion 464C repelling one another, a magnetic force that lifts the central magnet portion 464C is generated. Thus, by lowering the distal end portion 460B and the base end portion 460A of the paddle 460 and lifting the central portion 460C of the paddle 460, it is possible to suppress the central portion 460C of the paddle 460 from hanging down toward the ionically resistive element 450 side.

In this embodiment, as illustrated in FIG. 8, the plating apparatus 1000 includes a sensor 480 disposed to be opposed to the distal end portion 460B of the paddle 460 in the extending direction of the paddle 460. The sensor 480 is a distance sensor configured to measure a distance between the distal end portion 460B of the paddle 460 and the sensor 480. As the sensor 480, a known sensor such as an optical type sensor, a radio wave type sensor, or an ultrasonic wave type sensor can be used.

When the distance between the distal end portion 460B of the paddle 460 and the sensor 480 measured by the sensor 480 becomes larger than a predetermined threshold value, the plating apparatus 1000 can issue an alarm. That is, the magnetic force that suppresses the central portion 460C of the paddle 460 from hanging down toward the ionically resistive element 450 side is generated by disposing the first magnet 464 and the second magnets 468, and when the magnetic force becomes stronger, as illustrated by the dashed line B, the paddle 460 is arched so as to project upward. As this magnetic force becomes further stronger, the distal end portion 460B of the paddle 460 moves in a direction separating from the sensor 480. In other words, the distance between the sensor 480 and the distal end portion 460B of the paddle 460 increases as the central portion 460C of the paddle 460 arches so as to project toward the surface to be plated Wf-a side of the substrate Wf. When the paddle 460 arches beyond a predetermined range, the paddle 460 is likely to be brought into contact with the surface to be plated Wf-a of the substrate Wf. Therefore, when the distance between the sensor 480 and the distal end portion 460B of the paddle 460 becomes larger than the predetermined threshold value, the plating apparatus 1000, by issuing an alarm, can prompt an operator to stop the apparatus and perform inspections. The sensor 480 is not limited to this embodiment and can be applied to the embodiments illustrated in FIG. 5 to FIG. 7.

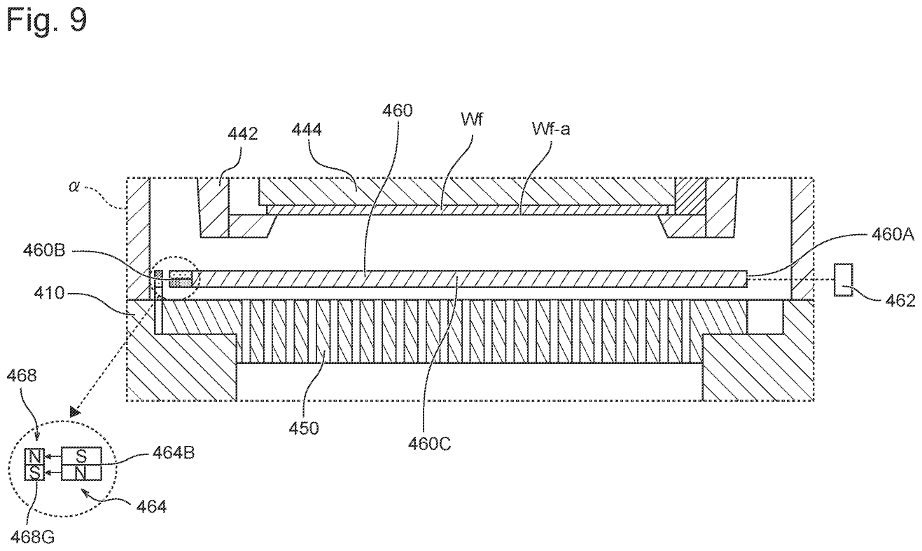

Next, a modification of the plating module 400 will be described. FIG. 9 is a vertical cross-sectional view schematically illustrating an enlarged part of a configuration of a plating module according to one embodiment.

In this embodiment, the first magnet 464 includes the distal-end magnet portion 464B disposed at the distal end portion 460B of the paddle 460. Specifically, the distal-end magnet portion 464B has the N-pole disposed at a lower portion and the S-pole disposed at an upper portion.

The second magnet 468 includes a third plating-tank magnet portion 468G disposed in the plating tank 410 to be opposed to the distal-end magnet portion 464B in the extending direction of the paddle 460. The third plating-tank magnet portion 468G is configured to exert an attractive magnetic force on the distal-end magnet portion 464B. Specifically, the third plating-tank magnet portion 468G has the S-pole disposed at a lower portion and the N-pole disposed at an upper portion. Accordingly, the magnetic force that attracts one another is generated between the third plating-tank magnet portion 468G and the distal-end magnet portion 464B. Since the third plating-tank magnet portion 468G is secured to the plating tank 410, the distal-end magnet portion 464B is attracted in a direction where the distal-end magnet portion 464B approaches the third plating-tank magnet portion 468G. Consequently, since bending of the paddle 460 due to gravity is eliminated, it is possible to suppress the central portion 460C of the paddle 460 from hanging down.

In the above, while some embodiments of the present invention have been described, the above-described embodiments of the present invention are intended to facilitate understanding of the present invention and are not intended to limit the present invention. The present invention can be modified and improved without departing from the gist of the present invention, and of course, the equivalents of the present invention are included in the present invention. It is possible to appropriately combine or omit respective components described in the claims and the specification in a range in which at least a part of the above-described problems can be solved, or in a range in which at least a part of the effects can be achieved.

This application discloses, as one embodiment, a plating apparatus that includes a plating tank for housing a plating solution, an anode disposed inside the plating tank, a substrate holder configured to hold a substrate with a surface to be plated facing downward, a paddle disposed between the anode and the substrate, a paddle driving mechanism configured to support a base end portion of the paddle and reciprocate the paddle along the surface to be plated of the substrate, a first magnet disposed in the paddle, and a second magnet disposed to be opposed to the first magnet. The first magnet and the second magnet are configured to exert a magnetic force on one another so as to cause a central portion between the base end portion and a distal end portion of the paddle to approach the surface to be plated of the substrate.

This application discloses, as one embodiment, the plating apparatus in which the first magnet includes a distal-end magnet portion disposed at the distal end portion of the paddle and having a distal-end-inside magnet portion and a distal-end-outside magnet portion disposed along an extending direction of the paddle. The second magnet includes a first inside magnet portion and a first outside magnet portion. The first inside magnet portion is disposed in the plating tank to exert a magnetic force that lifts the distal-end-inside magnet portion, and the first outside magnet portion is disposed in the plating tank to exert a magnetic force that lowers the distal-end-outside magnet portion.

This application discloses, as one embodiment, the plating apparatus in which the first magnet further includes a base-end magnet portion disposed at the base end portion of the paddle and having a base-end-inside magnet portion and a base-end-outside magnet portion disposed along the extending direction of the paddle. The second magnet further includes a second inside magnet portion and a second outside magnet portion. The second inside magnet portion is disposed in the plating tank to exert a magnetic force that lifts the base-end-inside magnet portion, and the second outside magnet portion is disposed in the plating tank to exert a magnetic force that lowers the base-end-outside magnet portion.

This application discloses, as one embodiment, the plating apparatus that further includes an ionically resistive element disposed between the anode and the paddle. The first magnet has a distal-end magnet portion disposed at the distal end portion of the paddle, a base-end magnet portion disposed at the base end portion of the paddle, and a central magnet portion disposed at the central portion of the paddle. The second magnet has a first plating-tank magnet portion, a second plating-tank magnet portion, and an ionically-resistive-element magnet portion. The first plating-tank magnet portion is disposed in the plating tank to exert a magnetic force that lowers the distal-end magnet portion, the second plating-tank magnet portion is disposed in the plating tank to exert a magnetic force that lowers the base-end magnet portion, and the ionically-resistive-element magnet portion is disposed on the ionically resistive element to exert a magnetic force that lifts the central magnet portion.

This application discloses, as one embodiment, the plating apparatus in which the second magnet includes a distal-end-opposition magnet portion disposed in the plating tank to be opposed to the distal-end magnet portion in the extending direction of the paddle and configured to exert a repulsive magnetic force on the distal-end magnet portion.

This application discloses, as one embodiment, the plating apparatus that further includes a sensor disposed to be opposed to the distal end portion of the paddle in the extending direction of the paddle and configured to measure a distance between the distal end portion of the paddle and the sensor.

This application discloses, as one embodiment, the plating apparatus in which the first magnet includes a distal-end magnet portion disposed at the distal end portion of the paddle. The second magnet includes a third plating-tank magnet portion disposed in the plating tank to be opposed to the distal-end magnet portion in the extending direction of the paddle and configured to exert an attractive magnetic force on the distal-end magnet portion.

### REFERENCE SIGNS LIST

400 . . . plating module
410 . . . plating tank
430 . . . anode
440 . . . substrate holder
450 . . . ionically resistive element
460 . . . paddle
460A . . . base end portion
460B . . . distal end portion
460C . . . central portion
462 . . . driving mechanism
464 . . . first magnet
464A . . . base-end magnet portion
464A-1 . . . base-end-inside magnet portion
464A-2 . . . base-end-outside magnet portion
464B . . . distal-end magnet portion
464B-1 . . . distal-end-inside magnet portion
464B-2 . . . distal-end-outside magnet portion
464C . . . central magnet portion
468 . . . second magnet
468A-1 . . . second inside magnet portion
468A-2 . . . second outside magnet portion
468B-1 . . . first inside magnet portion
468B-2 . . . first outside magnet portion
468C . . . distal-end-opposition magnet portion
468D . . . first plating-tank magnet portion
468E . . . second plating-tank magnet portion
468F . . . ionically-resistive-element magnet portion
468G . . . third plating-tank magnet portion
480 . . . sensor
1000 . . . plating apparatus
Wf . . . substrate
Wf-a . . . surface to be plated

1. A plating apparatus comprising:
a plating tank for housing a plating solution;
an anode disposed inside the plating tank;
a substrate holder configured to hold a substrate with a surface to be plated facing downward;
a paddle disposed between the anode and the substrate;
a paddle driving mechanism configured to support a base end portion of the paddle and reciprocate the paddle along the surface to be plated of the substrate;
a first magnet disposed in the paddle: and
a second magnet disposed to be opposed to the first magnet, wherein
the first magnet and the second magnet are configured to exert a magnetic force on one another so as to cause a central portion between the base end portion and a distal end portion of the paddle to approach the surface to be plated of the substrate.

2. The plating apparatus according to claim 1, wherein
the first magnet includes a distal-end magnet portion disposed at the distal end portion of the paddle and having a distal-end-inside magnet portion and a distal-end-outside magnet portion disposed along an extending direction of the paddle, and
the second magnet includes a first inside magnet portion and a first outside magnet portion, the first inside magnet portion is disposed in the plating tank to exert a magnetic force that lifts the distal-end-inside magnet portion, and the first outside magnet portion is disposed in the plating tank to exert a magnetic force that lowers the distal-end-outside magnet portion.

3. The plating apparatus according to claim 2, wherein
the first magnet further includes a base-end magnet portion disposed at the base end portion of the paddle and having a base-end-inside magnet portion and a base-end-outside magnet portion disposed along the extending direction of the paddle, and
the second magnet further includes a second inside magnet portion and a second outside magnet portion, the second inside magnet portion is disposed in the plating tank to exert a magnetic force that lifts the base-end-inside magnet portion, and the second outside magnet portion is disposed in the plating tank to exert a magnetic force that lowers the base-end-outside magnet portion.

4. The plating apparatus according to claim 1, further comprising
an ionically resistive element disposed between the anode and the paddle, wherein
the first magnet has a distal-end magnet portion disposed at the distal end portion of the paddle, a base-end magnet portion disposed at the base end portion of the paddle, and a central magnet portion disposed at the central portion of the paddle, and
the second magnet has a first plating-tank magnet portion, a second plating-tank magnet portion, and an ionically-resistive-element magnet portion, the first plating-tank magnet portion is disposed in the plating tank to exert a magnetic force that lowers the distal-end magnet portion, the second plating-tank magnet portion is disposed in the plating tank to exert a magnetic force that lowers the base-end magnet portion, and the ionically-resistive-element magnet portion is disposed on the ionically resistive element to exert a magnetic force that lifts the central magnet portion.

5. The plating apparatus according to any one of claims 2 to 4, wherein
the second magnet includes a distal-end-opposition magnet portion disposed in the plating tank to be opposed to the distal-end magnet portion in the extending direction of the paddle and configured to exert a repulsive magnetic force on the distal-end magnet portion.

6. The plating apparatus according to any one of claims 2 to 4, further comprising
a sensor disposed to be opposed to the distal end portion of the paddle in the extending direction of the paddle and configured to measure a distance between the distal end portion of the paddle and the sensor.

7. The plating apparatus according to claim 1, wherein
the first magnet includes a distal-end magnet portion disposed at the distal end portion of the paddle, and
the second magnet includes a third plating-tank magnet portion disposed in the plating tank to be opposed to the distal-end magnet portion in the extending direction of the paddle and configured to exert an attractive magnetic force on the distal-end magnet portion.
